(19) United States
(12) Patent Application Publication
(10) Pub. No.: US 2020/0409725 A1
(43) Pub. Date: Dec. 31, 2020

(54) METHOD FOR PAGE DISPLAYING, DISPLAY TERMINAL AND STORAGE MEDIUM

(71) Applicant: BEIJING XIAOMI MOBILE SOFTWARE CO., LTD., Beijing (CN)

(72) Inventors: Yihong ZHANG, Beijing (CN); Ying WANG, Beijing (CN)

(73) Assignee: BEIJING XIAOMI MOBILE SOFTWARE CO., LTD., Beijing (CN)

(21) Appl. No.: 16/740,349

(22) Filed: Jan. 10, 2020

(30) Foreign Application Priority Data
Jun. 28, 2019 (CN) 201910580258.6

(51) Int. Cl. G06F 9/451; G06F 3/0488; H04L 29/08

(52) U.S. Cl. CPC G06F 9/451; H04L 67/306; G06F 3/04883

(57) ABSTRACT

A method for page displaying includes: a first switching operation on a setting page is received from a user; a first interface is switched to a main interface based on the first switching operation, the first interface and the main interface being different interfaces before switching; and responsive to that a preset operation is detected, the first interface is displayed, the preset operation being used for instructing a terminal to display the main interface.

### CROSS-REFERENCE TO RELATED APPLICATION

This application claims priority to Chinese patent application No. 201910580258.6 filed on Jun. 28, 2019, the disclosure of which is hereby incorporated by reference in its entirety.

### BACKGROUND

A terminal device may usually have multiple display pages, and different Applications (APPs) or display contents are presented on different display pages. A user may switch different pages through a swipe operation to display them on a desktop, and to further operate an APP on the desktop or acquire information about time, weather and the like on the desktop. When a user executes an operation for presenting the desktop, for example, pressing a home button, the display page is usually returned to a default desktop page.

### SUMMARY

The present disclosure generally relates to the technical field of terminal devices, and more particularly, to a method for page displaying and device, a display terminal and a storage medium.

This summary is provided to introduce a selection of aspects of the present disclosure in a simplified form that are further described below in the Detailed Description. This summary is not intended to identify key features or essential features of the claimed subject matter, nor is it intended to be used to limit the scope of the claimed subject matter.

According to a first aspect of embodiments of the present disclosure, a method for page displaying is provided, which may include that:

a first switching operation on a setting page is received from a user;

a first interface is switched to a main interface based on the first switching operation, the first interface and the main interface being different interfaces before switching; and

upon that a preset operation is detected, the first interface is displayed, the preset operation being used for instructing a terminal to display the main interface.

According to a second aspect of the embodiments of the present disclosure, a display terminal is provided, which may include a processor, a transceiver, a memory and an executable program stored in the memory and runnable by the processor, wherein the processor may run the executable program to execute the blocks of the method for page displaying of the first aspect.

According to a third aspect of the embodiments of the present disclosure, a storage medium is provided, in which an executable program may be stored, wherein the executable program may be executed by a processor to implement the blocks of the method for page displaying of the first aspect.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a structure diagram of a wireless communication system according to an exemplary embodiment.

FIG. 2 is a flowchart illustrating a method for page displaying according to an exemplary embodiment.

FIG. 3 is a structure diagram of composition of a device for page displaying according to an exemplary embodiment.

FIG. 4 is a structure diagram of composition of another device for page displaying according to an exemplary embodiment.

FIG. 5 is a structure diagram of composition of yet another device for page displaying according to an exemplary embodiment.

FIG. 6 is a structure diagram of composition of still another device for page displaying according to an exemplary embodiment.

FIG. 7 is a structure diagram of composition of still another device for page displaying according to an exemplary embodiment.

FIG. 8 is a structure diagram of composition of still another device for page displaying according to an exemplary embodiment.

FIG. 9 is a structure diagram of composition of still another device for page displaying according to an exemplary embodiment.

FIG. 10 is a structure diagram of composition of still another device for page displaying according to an exemplary embodiment.

FIG. 11 is a block diagram of a device for page displaying according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments of the present disclosure. Instead, they are merely examples of apparatuses and methods consistent with aspects related to the embodiments of the present disclosure as recited in the appended claims.

Terminologies used in the embodiments of the present disclosure are only adopted for the purpose of describing specific embodiments and not intended to limit the embodiments of the present disclosure. The singular terms “a/an”, “said” and “the” in the embodiments of the present disclosure and the appended claims are also intended to represent plurality, unless other meanings are clearly denoted throughout the present disclosure. It is also to be understood that terminology “and/or” used in the present disclosure refers to and includes one or any or all possible combinations of multiple associated items that are listed.

It is to be understood that, although terminologies first, second, third and the like may be adopted to describe various information in the embodiments of the present disclosure, the information should not be limited to these terminologies. These terminologies are only adopted to distinguish the information of the same type. For example, without departing from the scope of the embodiments of the present disclosure, first information may also be called second information and, similarly, second information may also be called first information. For example, terminology “if” used herein may be explained as “while” or “when” or “responsive to determining”, which depends on the context.

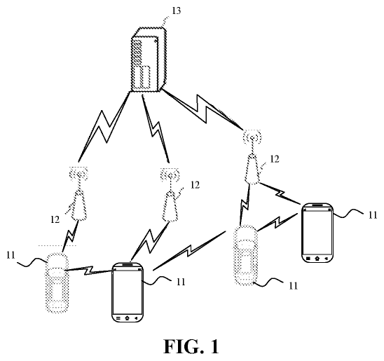

Referring to FIG. 1, a structure diagram of a wireless communication system provided in an embodiment of the present disclosure is illustrated. As shown in FIG. 1, the wireless communication system is a cellular mobile communication technology-based communication system. The wireless communication system may include a plurality of terminals 11 and a plurality of base Stations (STAs) 12.

The terminal 11 may refer to a device for providing voice and/or data connectivity for a user. The terminal 11 may communicate with one or more core networks through a Radio Access Network (RAN). The terminal 11 may be an Internet of things terminal, for example, a sensor device, a mobile phone (or called a “cell” phone) and a computer with an Internet of things terminal. For example, the terminal 11 may be a fixed, portable, pocket-sized, handheld, computer-embedded or vehicle-mounted device, for example, an STA, a subscriber unit, a subscriber STA, a mobile STA, a mobile, a remote STA, an access point, a remote terminal, an access terminal, a user terminal, a user agent, a user device or User Equipment (UE). Or, the terminal 11 may also be a device of an unmanned aerial vehicle. Or, the terminal 11 may also be a vehicle-mounted device and, for example, may be a trip computer with a wireless communication function or a wireless communication device connected with an external trip computer. Or, the terminal 11 may also be a roadside unit and, for example, may be a street lamp, a signal lamp or other roadside units with the wireless communication function.

The base STA 12 may be a network-side device in a wireless communication system. The wireless communication system may be a 4th Generation mobile communication (4G) system, also called a Long-Term Evolution (LTE) system. Or, the wireless communication system may also be a 5th-Generation (5G) system, also called a New Radio (NR) or 5G NR system. Or, the wireless communication system may also be a next-generation system of the 5G system. An access network in the 5G system is called a New Generation-Radio Access Network (NG-RAN), or, a Machine Type Communication (MTC) system.

The base STA 12 may be an Evolved Node B (eNB) in the 4G system. Or, the base STA 12 may also be a gNB adopting a central distributed architecture in the 5G system. The base STA 12, when adopting the central distributed architecture, usually includes a Central Unit (CU) and at least two Distributed Units (DUs). Protocol stacks of a Packet Data Convergence Protocol (PDCP) layer, a Radio Link Control (RLC) layer and a Media Access Control (MAC) layer are arranged in the CU. A protocol stack of a Physical (PHY) layer is arranged in the DU. A specific implementation of the base STA 12 is not limited in the embodiment of the present disclosure.

The base STA 12 may establish a wireless connection with the terminal 11 through a radio interface. In different implementation modes, the radio interface may be a 4G-standard-based radio interface; or, the radio interface may be a 5G-standard-based radio interface, for example, the radio interface is an NR interface; or, the radio interface may also be a radio interface based on a next-generation mobile communication network technology standard of 5G.

In some embodiments, the terminals 11 may also establish End to End (E2E) connections with one another, for example, Vehicle to Vehicle (V2C) communication, Vehicle to Infrastructure (V2I) communication, Vehicle to Pedestrian (V2P) communication and the like in Vehicle to Everything (V2X).

In some embodiments, the wireless communication system may further include a network management device 13.

The plurality of base STAs 12 are connected with the network management device 13 respectively. The network management device 13 may be a core network device in the wireless communication system. For example, the network management device 13 may be a Mobility Management Entity (MME) in an Evolved Packet Core (EPC). Or, the network management device may also be other core network devices, for example, a Serving GateWay (SGW), a Public Data Network GateWay (PGW), a Policy and Charging Rules Function (PCRF) or a Home Subscriber Server (HSS). An implementation of the network management device 13 is not limited in the embodiment of the present disclosure.

An execution body involved in the embodiment of the present disclosure includes, but not limited to, a mobile terminal.

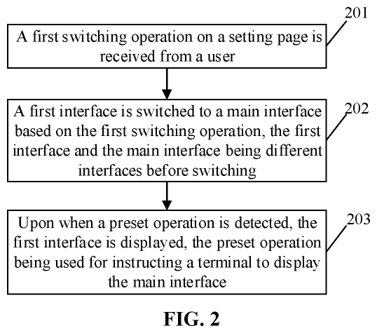

FIG. 2 is a flowchart illustrating a method for page displaying according to an exemplary embodiment. As shown in FIG. 2, the method for page displaying may be applied to a terminal and includes the following blocks.

In Block 201, a first switching operation on a setting page is received from a user.

In Block 202, a first interface is switched to a main interface based on the first switching operation, the first interface and the main interface being different interfaces before the first switching operation is performed.

In Block 203, upon that a preset operation is detected, the first interface is displayed, the preset operation being for instructing a terminal to display the main interface.

The setting page may be a page on which the terminal displays prompting information to a user and provides an operation option. A prompting content of the prompting information may be information asking the user for opinions and the like such as “whether to confirm desktop replacement or not” or “whether to enable an automatic desktop replacement function or not”. The user may confirm or cancel an operation through the operation option.

The first switching operation may be an operation of determining interface switching.

The main interface may be a default desktop of the terminal, and the first interface may be any other interface than the default display desktop of the terminal.

Switching between the main interface and the first interface may be carried out through a finger swipe operation and the like of the user over a screen of the terminal.

The preset operation may refer to an operation that the terminal returns to the main interface from any interface, for example, a user operation on a home button, or a finger swipe operation of returning to the desktop, or a closing operation of exiting from an APP to a main interface, or an operation of starting the terminal.

Here, the first interface is switched to the main interface through the first switching operation, namely the first interface is set as the desktop. After switching, upon that preset operations, such as starting the terminal and clicking the home button, are executed, the terminal may directly display the first interface without need of manually switching the main interface that is displayed as a default to the first interface after the preset operation is performed, so that convenience is improved for the user, and a user experience is improved. Moreover, operations unauthorized by the user may be reduced through confirmation of the user.

In an embodiment, before the first interface is switched to the main interface, the first interface includes a MinusOneScreenView interface; and the method may further include that: before the first switching operation on the setting page is received from the user, the setting page is displayed.

The MinusOneScreenView interface may be an interface of the terminal, which is displayed as the desktop after a switching operation such as a rightward swipe is performed on the default desktop.

The user may actively enter the setting page to make a setting, or displaying of the setting page may be triggered according to a triggering event. The triggering event may be that the time for operating the first interface exceeds a preset time length.

The setting page may be displayed on the first interface by popping up prompting information or by other ways to prompt the user whether to determine desktop replacement or not or whether to enable the automatic desktop replacement function or not. The setting page may also be displayed on the full screen. The desktop prompting information may be popped up on the first interface, and after the user confirms desktop replacement, a desktop content may still be the first interface. In a situation that desktop prompting information is popped up on the main interface presently operated by the user, the desktop may be switched to the first interface after the user confirms desktop replacement, while the user is needed to execute a swipe operation to return to the main interface and thus an additional operation is required. Popping up desktop prompting information on the first interface can reduce unnecessary operations and improve the user experience.

In an embodiment, the operation that the setting page is displayed may include that: a second switching operation is detected; the main interface is switched to the first interface based on the second switching operation, and switching information about the switching from the main interface to the first interface is recorded; and when the switching information meets a preset condition, the setting page is displayed.

The second switching operation may be a leftward or rightward swipe and the like operation of the user on the screen of the terminal. When the second switching operation is executed, the terminal may be switched from the main interface to the first interface. For example, the main interface is the presently displayed interface, the first interface is the MinusOneScreenView interface, and the MinusOneScreenView interface becomes a displayed interface through a rightward swipe of the finger of the user on the screen of the terminal. Here, the rightward swipe is the second switching operation. The main interface may be displayed again through a leftward swipe of the finger of the user on the screen of the terminal.

The “MinusOneScreenView” interface can also be referred to a “HiBoard” interface, and can be an interface with aggregated applications (Apps) for the user's convenience.

A touch screen in the terminal may sense the second switching operation, and a processor and the like may make a response to the second switching operation.

The switching information may be the number of times, duration, frequency and the like of the switching from the main interface to the first interface. The switching information may also be a ratio of a duration of staying on the first interface relative to a duration of staying on any other interface within a predetermined time bucket, based on entry time and exit time of the first interface.

The preset condition may be set according to an operation habit of the user and the like. For example, a longest display duration is determined from the display durations of pages for the user as a display duration threshold. When a display duration, obtained according to the switching information, of the first interface is greater than the display duration threshold, the setting page is displayed. The user determines whether to replace the main interface with the first interface as the default desktop or not.

According to the operation habit of the user, upon that the switching information, such as the switching time of the first interface, for the user meets the preset condition, the setting page is displayed, and the user determines to replace the main interface with the first interface as the default desktop. After the first interface is switched to the main interface, the first interface may be directly displayed after the user clicks the home button or executes other preset operations. Accordingly, without the block that the user manually switches the main interface that is displayed as a default to the first interface after the preset operation is performed, convenience is improved for the user, and the user experience is improved.

In an embodiment, the operation that the setting page is displayed when the switching information meets the preset condition may include that: when a using frequency, determined based on the switching information, of the first interface meets the preset condition, the setting page is displayed.

Here, the using frequency meeting the preset condition may be that the using frequency exceeds a using frequency threshold, etc. For example, when the using frequency of the first interface exceeds the preset frequency threshold, the setting page is displayed. The using frequency of the first interface may also be compared with a using frequency of another page to obtain a difference, and if the difference exceeds the preset frequency threshold, the setting page is displayed.

In an embodiment, the operation that the switching information about the switching from the main interface to the first interface is recorded may include that:

information about entry time is recorded about the switching from the main interface to the first interface; and the method may further include that: exit time information is recorded about exit from the first interface, the using frequency of the first interface being determined according to the information about the entry time and the information about the exit time.

Here, the using frequency of the first interface may be determined according to the information about the entry time and the information about the exit time in multiple manners. For example, formation of a piece of information about entry time is determined as use of the first interface once, or, formation of information about adjacent entry time and exit time is determined as use of the first interface once. The number of times of use of the first interface within a preset time may be determined as the using frequency of the first interface.

In an embodiment, the method may further include that: the information about the entry time and the information about the exit time are reported to a server, and an interface change instruction sent by the server when determining according to the information about the entry time and the information about the exit time that the using frequency of the first interface meets the preset condition is received; and the operation that the setting page is displayed when the using frequency, determined based on the switching information, of the first interface meets the preset condition may include that: the setting page is displayed based on the interface change instruction.

The server may be local, or may be located at a network such as cloud.

The operation habit, such as the information about the entry time and the information about the exit time, of the user is reported to the server, and the server determines the using frequency of the first interface and sends a desktop change instruction. Whether the preset condition that is presently adopted meets the using habit of the user or not may be determined in combination with a historical record. For example, whether a present frequency value truly reflects a requirement of the user on a desktop display page or not may be determined. The preset condition may be dynamically adjusted to improve accuracy of an alternative desktop recommended to the user.

The terminal reports the operation habit such as the information about the entry time and exit time information of the first interface to the server through a network and the like. The server, when determining according to the information reported by the terminal that the using frequency of the first interface meets the preset condition, sends the desktop change instruction to the terminal through the network and the like. The terminal, after receiving the desktop change instruction, may request for confirmation of the user through the setting page. If the user confirms, the terminal replaces the main interface with the first interface and displays the first interface as the desktop.

In an embodiment, the operation that the using frequency of the first interface is determined according to the information about the entry time and the information about the exit time may include that: if a difference between exit time and entry time is greater than a preset duration, it is determined that the switching from the main interface to the first interface is use of the first interface once; and the using frequency of the first interface is determined according to the number of times of use of the first interface.

Here, the difference between the entry time and the exit time may be considered as stay time of the user on the first interface, and when the stay time is longer than a preset duration, it is considered that the user is using the first interface rather than reaching to any other interface through the first interface or making a misoperation on the first interface.

The number of times of use of the first interface within a preset time bucket may be determined as the using frequency of the first interface. The preset time bucket may be a day, a week or the like and may be defined according to the operation habit of the user.

In an embodiment, the operation that the first interface is switched to the main interface may include that: a first index of the main interface in a desktop configuration field in a global setting is modified into a second index of the first interface; and the operation that the first interface is displayed when the preset operation is detected may include that: upon that the preset operation is detected under any user account, the first interface is displayed.

During a specific application, both the first interface and the main interface have corresponding indexes. For example, the index of the main interface, i.e., the default desktop display page, is “1”, and the first interface is a MinusOneScreenView and has the index “−1”. The index “−1” of the MinusOneScreenView may be set in the global setting, and the desktop is notified to modify the MinusOneScreenView. When the user presses the home button or restarts a mobile phone next time, a system reads the index of the desktop from the global setting, and if it is “−1”, a page of which an index is “−1” is set as the desktop in a desktop launcher.

Here, setting made through the global setting may replace the desktop for each user account which is logged in at the terminal.

In an embodiment, the operation that the first interface is switched to the main interface may include that:

the first index of the main interface in a desktop configuration field in a user setting of a target user account is modified into the second index of the first interface; and

the operation that the first interface is displayed upon that the preset operation is detected may include that:

upon that the preset operation is detected under the target user account, the first interface is displayed.

During a specific application, both the first interface and the main interface have corresponding indexes. For example, the index of the main interface, i.e., the present desktop display page, is “1”, and the first interface is the MinusOneScreenView and has the index “−1”. The index “−1” of the MinusOneScreenView may be set in the user setting, and the desktop is notified to modify the MinusOneScreenView. When the user presses the home button or restarts the mobile phone next time, the system reads the index of the desktop from the user setting, and if it is “−1”, the page of which the index is “−1” is set as the desktop in the launcher.

Here, setting made through the target user account may replace the desktop for the user which is logging in the terminal.

Combining the global setting and the user setting may flexibly replace the desktop page for all users or a single user for adaptation to different application scenarios.

In an embodiment, the method may further include that: before the first interface is switched to the main interface, the main interface is switched to the first interface based on a first swipe instruction which acts on the main interface and of which a swipe direction is a first direction.

When the first interface is switched to the main interface, the first interface is switched to the main interface based on a second swipe instruction which acts on the first interface and of which a swipe direction is a second direction, the second direction being an opposite direction of the first direction; or, when the first interface is switched to the main interface, the first interface is switched to the main interface based on the second swipe instruction which acts on the first interface and of which the swipe direction is the first direction.

After the first interface is switched to the main interface, the first interface is a desktop display page, and the main interface is an un-displayed page.

Under a circumstance, pages of the terminal are sequentially and non-cyclically displayed through swipe operations and the like, namely the pages may be switched from the first page to the last page one by one through the swipe operations in the same direction and, when the last page is reached, inverse operations may be executed to switch the pages from the last page to the first page one by one. Under this circumstance, if the main interface is switched to the first interface through the first swipe instruction in the first direction, then the first interface is required to be switched to the main interface through the second swipe instruction in the second direction opposite to the first direction after the first interface replaces the main interface.

Under another circumstance, the pages of the terminal may be cyclically displayed through swipe operations and the like, namely the pages may be switched from the first page to the last page one by one through the swipe operations in the same direction and, when the last page is reached, operations are still executed in the same direction to directly switch the last page back to the first page. Under this circumstance, if the main interface is switched to the first interface through the first swipe instruction in the first direction, then the first interface may still be switched to the main interface through the second swipe instruction in the first direction after the first interface replaces the main interface. The first swipe instruction and the second swipe instruction may be the same instruction, and “first” and “second” are only adopted to distinguish two swipe instructions.

A specific example will be provided below in combination with any above-mentioned embodiment.

When the user invokes the MinusOneScreenView, a client may record and report a difference of entry and exit time of the user to the server. The server stores this record of the device into a database and then queries a historical record of the user to evaluate whether the user uses the MinusOneScreenView at a high frequency or not. When a certain frequency is met, a value “true” is returned to indicate whether to prompt the user to set the MinusOneScreenView as a main screen or not next time when the user invokes the MinusOneScreenView. The device pops up a user interface to request the user for confirming whether to adopt an intelligent desktop setting or not. For example, a button “try” is displayed, and after the user clicks “try”, a user result is reported to the server. The MinusOneScreenView stores such a setting in the global setting, and the desktop is notified to modify the MinusOneScreenView as the main screen. After the user presses Home and restarts the mobile phone next time, the desktop reads the index of the main screen from the setting, and if it is −1, MinusOneScreenView in the launcher is determined as the view of which the index is −1 in the launcher. The main screen is the default desktop display page, under which state the MinusOneScreenView is a page displayed on the desktop through a rightward swipe operation of the user.

The operation habit of the user is reported to the server as a default for the purpose of dynamically adjusting a threshold about whether the user is a high-frequency user or not to improve the accuracy of the recommended alternative main screen.

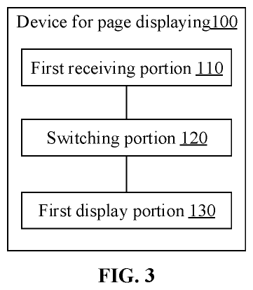

FIG. 3 is a block diagram of a device for page displaying 100 according to an exemplary embodiment. Referring to FIG. 3, the device includes a first receiving portion 110, a switching portion 120 and a first display portion 130, wherein

the first receiving portion 110 is configured to receive a first switching operation on a setting page from a user;

the switching portion 120 is configured to switch a first interface to a main interface based on the first switching operation, the first interface and the main interface being different interfaces before switching; and

the first display portion 130 is configured to, responsive to that a preset operation is detected, display the first interface, the preset operation being used for instructing a terminal to display the main interface.

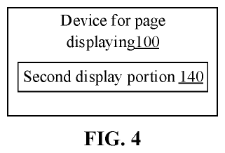

In an embodiment, as shown in FIG. 4, before the first interface is switched to the main interface, the first interface may include a MinusOneScreenView interface; and

the device 100 may further include:

a second display portion 140, configured to, before the first switching operation on the setting page is received from the user, display the setting page.

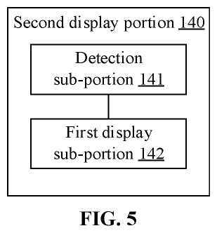

In an embodiment, as shown in FIG. 5, the second display portion 140 may further include:

a detection sub-portion 141, configured to detect a second switching operation, switch the main interface to the first interface based on the second switching operation and record switching information about switching from the main interface to the first interface; and

a first display sub-portion 142, configured to, when the switching information meets a preset condition, display the setting page.

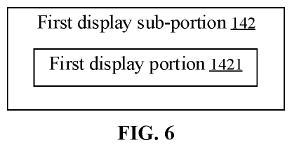

In an embodiment, as shown in FIG. 6, the first display sub-portion 142 may include:

a first display portion 1421, configured to, when a using frequency, determined based on the switching information, of the first interface meets the preset condition, display the setting page.

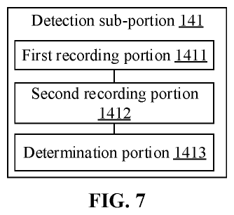

In an embodiment, as shown in FIG. 7, the detection sub-portion 141 may include:

a first recording portion 1411, configured to record information about entry time of switching from the main interface to the first interface;

a second recording portion 1412, configured to record information about exit time of exiting from the first interface; and

a determination portion 1413, configured to determine the using frequency of the first interface according to the information about the entry time and the information about the exit time.

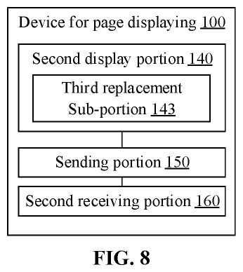

In an embodiment, as shown in FIG. 8, the device 100 may further include:

a sending portion 150, configured to report the information about the entry time and the information about the exit time to a server, and

a second receiving portion 160, configured to receive an interface change instruction which is sent by the server when determining according to the information about the entry time and the information about the exit time that the using frequency of the first interface meets the preset condition.

The second display portion 140 may further include:

a second display sub-portion 143, configured to display the setting page based on the interface change instruction.

In an embodiment, the determination unit 1413 is specifically configured to:

when a difference between exit time and entry time is greater than a preset duration, determine that switching from the main interface to the first interface is use of the first interface once; and

determine the using frequency of the first interface according to the number of times of use of the first interface.

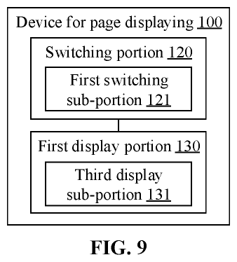

In an embodiment, as shown in FIG. 9, the switching portion 120 may include:

a first switching sub-portion 121, configured to modify a first index of the main interface in a desktop configuration field in a global setting into a second index of the first interface.

The first display module 130 may include:

a third display sub-portion 131, configured to, upon that the preset operation is detected under any user account, display the first interface.

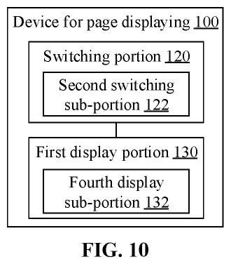

In an embodiment, as shown in FIG. 10, the switching portion 120 may include:

a second switching sub-portion 122, configured to modify the first index of the main interface in a desktop configuration field in a user setting of a target user account into the second index of the first interface.

The first display portion 130 may include:

a fourth display sub-portion 132, configured to, upon that the preset operation is detected under the target user account, display the first interface.

With respect to the device in the above embodiment, the manners for performing operations by individual portions therein have been described in detail in the embodiment of the method, which will not be elaborated herein.

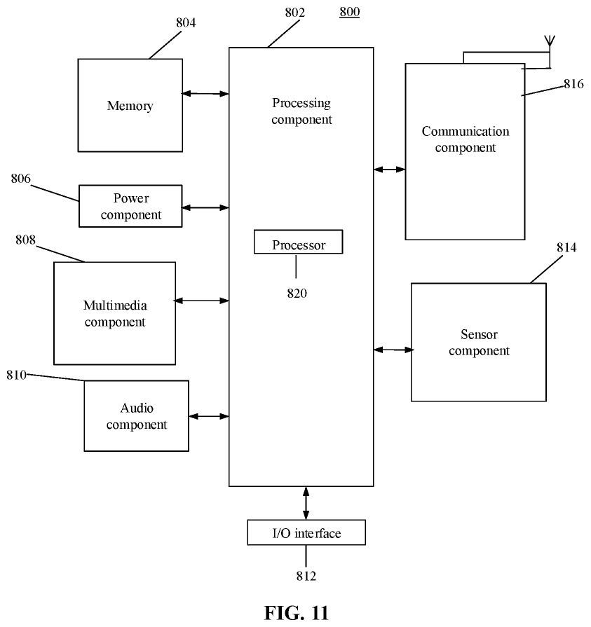

FIG. 11 is a block diagram of a display terminal device 800 according to an exemplary embodiment. For example, the device 800 may be a mobile phone, a computer, a digital broadcast terminal, a messaging device, a gaming console, a tablet, a medical device, exercise equipment, a personal digital assistant and the like.

Referring to FIG. 11, the device 800 may include one or more of the following components: a processing component 802, a memory 804, a power component 806, a multimedia component 808, an audio component 810, an Input/Output (I/O) interface 812, a sensor component 814, and a communication component 816.

The processing component 802 is typically configured to control overall operations of the device 800, such as the operations associated with display, telephone calls, data communications, camera operations, and recording operations. The processing component 802 may include one or more processors 820 to execute instructions to perform all or part of the blocks in the above-mentioned method. Moreover, the processing component 802 may include one or more portions which facilitate interaction between the processing component 802 and other components. For instance, the processing component 802 may include a multimedia portion to facilitate interaction between the multimedia component 808 and the processing component 802.

The memory 804 is configured to store various types of data to support the operation of the device 800. Examples of such data include instructions for any APP programs or methods operated on the device 800, contact data, phonebook data, messages, pictures, video, etc. The memory 804 may be implemented by any type of volatile or non-volatile memory devices, or any combination thereof, such as an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 is for providing power for various components of the device 800. The power component 806 may include a power management system, one or more power supplies, and other components associated with generation, management and distribution of power for the device 800.

The multimedia component 808 may include a screen for providing an output interface between the device 800 and a user. In some embodiments, the screen may include a Liquid Crystal Display (LCD) and a Touch Panel (TP). In some embodiments, organic light-emitting diode (OLED) or other types of displays can be employed. In a case that the screen includes the TP, the screen may be implemented as a touch screen to receive an input signal from a user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 808 may include a front camera and/or a rear camera. The front camera and/or the rear camera may receive external multimedia data when the device 800 is in an operation mode, such as a photographing mode or a video mode. Each of the front camera and the rear camera may be a fixed optical lens system or have capabilities in focusing and optical zooming.

The audio component 810 is configured to output and/or input an audio signal. For example, the audio component 810 may include a Microphone (MIC), and the MIC is configured to receive an external audio signal when the device 800 is in the operation mode, such as a calling mode, a recording mode and a voice recognition mode. The received audio signal may further be stored in the memory 804 or sent through the communication component 816. In some embodiments, the audio component 810 may further include a speaker configured to output the audio signal.

The I/O interface 812 is for providing an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the device 800. For instance, the sensor component 814 may detect an on/off status of the device 800 and relative positioning of components, such as a display and a small keyboard of the device 800, and the sensor component 814 may further detect a change in a position of the device 800 or a component of the device 800, presence or absence of contact between the user and the device 800, orientation or acceleration/deceleration of the device 800 and a change in temperature of the device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging APP. In some embodiments, the sensor component 814 may also include an acceleration sensor, a gyroscope sensor, a magnetic sensor, a pressure sensor or a temperature sensor.

The communication component 816 is configured to facilitate wired or wireless communication between the device 800 and other equipment. The device 800 may access a communication-standard-based wireless network, such as a Wireless Fidelity (Wi-Fi) network, a 2nd-Generation (2G), 3rd-Generation (3G), 4^{th}-Generation (4G), or 5^{th}-Generation (5G) network or any combination thereof. In an exemplary embodiment, the communication component 816 is configured to receive a broadcast signal or broadcast associated information from an external broadcast management system through a broadcast channel. In an exemplary embodiment, the communication component 816 may further include a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and other technologies.

In an exemplary embodiment, the device 800 may be implemented by one or more ASICs, DSPs, Digital Signal Processing Devices (DSPDs), Programmable Logic Devices (PLDs), Field Programmable Gate Arrays (FPGAs), controllers, micro-controllers, microprocessors or other electronic components, and is configured to execute the above-mentioned method.

In an exemplary embodiment, there is also provided a non-transitory computer-readable storage medium including an instruction, such as the memory 804 including an instruction, and the instruction may be executed by the processor 820 of the device 800 to implement the above-mentioned method. For example, the non-transitory computer-readable storage medium may be a ROM, a Compact Disc Read-Only Memory (CD-ROM), a magnetic tape, a floppy disc, an optical data storage device and the like.

According to a non-transitory computer-readable storage medium, when an instruction in the storage medium is executed by a processor of a mobile terminal to enable the mobile terminal to execute the blocks of the method for page displaying.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

In the description of the present disclosure, the terms “some embodiments,” “example,” or “some examples,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombinations.

Moreover, although features can be described above as acting in certain combinations and even initially claimed as such, one or more features from a claimed combination can in some cases be excised from the combination, and the claimed combination can be directed to a subcombination or variations of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A method for page displaying, comprising:
receiving a first switching operation on a setting page from a user;
switching a first interface to a main interface based on the first switching operation, the first interface and the main interface being different interfaces before switching; and
upon that a preset operation is detected, displaying the first interface, wherein the preset operation is configured to instruct a terminal to display the main interface.

2. The method of claim 1, wherein the first interface comprises a MinusOneScreenView interface; and the method further comprises:
prior to that the first switching operation on the setting page is received from the user, displaying the setting page.

3. The method of claim 2, wherein the displaying the setting page comprises:
detecting a second switching operation;
switching the main interface to the first interface based on the second switching operation,
recording switching information about switching from the main interface to the first interface; and
upon that the switching information meets a preset condition, displaying the setting page.

4. The method of claim 3, wherein the displaying the setting page upon that the switching information meets the preset condition comprises:
upon that a using frequency, determined based on the switching information, of the first interface meets the preset condition, displaying the setting page.

5. The method of claim 4, wherein the recording the switching information about switching from the main interface to the first interface comprises:
recording information about entry time of switching from the main interface to the first interface; and
the method further comprises:
recording information about exit time of exiting from the first interface,
wherein the using frequency of the first interface is determined according to the information about the entry time and the information about the exit time.

6. The method of claim 5, further comprising:
reporting the information about the entry time and the information about the exit time to a server; and
receiving an interface change instruction which is sent by the server when the using frequency of the first interface is determined according to the information about the entry time and the information about the exit time to meet the preset condition,
wherein displaying the setting page when the using frequency, determined based on the switching information, of the first interface meets the preset condition comprises: displaying the setting page based on the interface change instruction.

7. The method of claim 5, wherein the determining the using frequency of the first interface according to the information about the entry time and the information about the exit time comprises:
responsive to that a difference between the exit time and the entry time is greater than a preset duration, determining that switching from the main interface to the first interface is use of the first interface once; and
determining the using frequency of the first interface according to the number of times of use of the first interface.

8. The method of claim 1, wherein
the switching the first interface to the main interface comprises:
modifying a first index of the main interface in a desktop configuration field in a global setting into a second index of the first interface; and
the displaying the first interface upon that the preset operation is detected comprises:
upon that the preset operation is detected under any user account, displaying the first interface.

9. The method of claim 1, wherein
the switching the first interface to the main interface comprises:
modifying a first index of the main interface in a desktop configuration field in a user setting of a target user account into a second index of the first interface; and
the displaying the first interface upon that the preset operation is detected comprises:
upon that the preset operation is detected under the target user account, displaying the first interface.

10. The method of claim 6, wherein determining the using frequency of the first interface according to the information about the entry time and the information about the exit time comprises:
responsive to that a difference between the exit time and the entry time is greater than a preset duration, determining that switching from the main interface to the first interface is use of the first interface once; and
determining the using frequency of the first interface according to the number of times of use of the first interface.

11. A terminal, comprising a processor, a transceiver, a memory and an executable program stored in the memory and runnable by the processor, wherein the processor runs the executable program to execute steps of:
controlling the transceiver to receive a first switching operation on a setting page from a user;
switching a first interface to a main interface based on the first switching operation, the first interface and the main interface being different interfaces before switching; and
upon when a preset operation is detected, controlling a display to display the first interface, wherein the preset operation is used for instructing a terminal to display the main interface.

12. The terminal of claim 11, wherein the first interface comprises a MinusOneScreenView interface; and the processor further runs the executable program to further execute a step of:
before the first switching operation on the setting page is received from the user, controlling the display to display the setting page.

13. The terminal of claim 12, wherein the processor further runs the executable program to further execute steps of:
detecting a second switching operation;
switching the main interface to the first interface based on the second switching operation,
recording switching information about switching from the main interface to the first interface; and
upon when the switching information meets a preset condition, controlling the display to display the setting page.

14. The terminal of claim 13, wherein the processor further runs the executable program to further execute a step of:
upon when a using frequency, determined based on the switching information, of the first interface meets the preset condition, controlling the display to display the setting page.

15. The terminal of claim 14, wherein the processor further runs the executable program to further execute steps of:
recording information about entry time of switching from the main interface to the first interface; and
recording information about exit time of exiting from the first interface,
wherein the using frequency of the first interface is determined according to the information about the entry time and the information about the exit time.

16. The terminal of claim 15, wherein the processor further runs the executable program to further execute steps of:
controlling the transceiver to report the information about the entry time and the information about the exit time to a server; and
controlling the transceiver to receive an interface change instruction which is sent by the server when the using frequency of the first interface is determined according to the information about the entry time and the information about the exit time to meet the preset condition,
wherein when controlling the display to display the setting page when the using frequency, determined based on the switching information, of the first interface meets the preset condition, the processor runs the executable program to control the display to display the setting page based on the interface change instruction.

17. The terminal of claim 15, wherein the processor further runs the executable program to further execute steps of:
when a difference between the exit time and the entry time is greater than a preset duration, determining that switching from the main interface to the first interface is use of the first interface once; and
determining the using frequency of the first interface according to the number of times of use of the first interface.

18. The terminal of claim 11, wherein the processor further runs the executable program to further execute steps of:
modifying a first index of the main interface in a desktop configuration field in a global setting into a second index of the first interface; and
upon when the preset operation is detected under any user account, controlling the display to display the first interface.

19. The terminal of claim 11, wherein the processor further runs the executable program to further execute steps of:
modifying a first index of the main interface in a desktop configuration field in a user setting of a target user account into a second index of the first interface; and
upon when the preset operation is detected under the target user account, controlling the display to display the first interface.

20. A non-transitory computer-readable storage medium having a program stored thereon, for execution by a processor to implement operations of the method of claim 1.
